(19) United States
(12) Patent Application Publication
(10) Pub. No.: US 2025/0292951 A1
(43) Pub. Date: Sep. 18, 2025

(54) COIL COMPONENT

(71) Applicant: TDK CORPORATION, Tokyo (JP)

(72) Inventors: Yusuke NAGAI, Tokyo (JP); Makoto YOSHINO, Tokyo (JP); Hidenobu UMEDA, Tokyo (JP); Shinichi SATO, Tokyo (JP); Shingo HATTORI, Tokyo (JP); Youhei IIDA, Tokyo (JP); Mitsuharu KOIKE, Tokyo (JP); Keito YASUDA, Tokyo (JP); Takuya MIYASHITA, Tokyo (JP)

(73) Assignee: TDK CORPORATION, Tokyo (JP)

(21) Appl. No.: 19/064,983

(22) Filed: Feb. 27, 2025

(30) Foreign Application Priority Data
Mar. 14, 2024 (JP) 2024-039814

(51) Int. Cl. H01F 27/29

(52) U.S. Cl. CPC H01F 27/292

(57) ABSTRACT

A coil component includes: an element body including soft magnetic metal particles; a coil disposed inside the element body; and an external electrode connected to the coil. The external electrode includes a base metal layer provided on an outer surface of the element body, and a plating layer covering the base metal layer. The plating layer includes a protruding portion provided on an outer edge portion of the plating layer, and penetrating into the element body.

### TECHNICAL FIELD

The present disclosure relates to a coil component. The present application claims priority to Japanese Patent Application No. 2024-039814 filed on Mar. 14, 2024, the content of which is incorporated herein by reference in its entirety.

### BACKGROUND

A coil component including an element body, a coil disposed inside the element body, and an external electrode connected to the coil is known (see, for example, JP 2020-141079A). JP 2020-141079A discloses that a passive component is mounted on a circuit board by the external electrode of the passive component being joined to a land pattern with solder.

### SUMMARY

It is an object of the present disclosure to provide a coil component that is capable of improving the bonding strength between an external electrode and solder.

(1) A coil component according to an embodiment of the present disclosure includes: an element body including soft magnetic metal particles; a coil disposed inside the element body; and an external electrode connected to the coil, wherein the external electrode includes a base metal layer provided on an outer surface of the element body, and a plating layer covering the base metal layer, and wherein the plating layer includes a protruding portion provided on an outer edge portion of the plating layer, and penetrating into the element body.

In the coil component above, the plating layer has the protruding portion that penetrates into the element body. Thus, a surface area of the plating layer that bonds with solder is increased compared to a configuration in which the plating layer does not have a protruding portion. This makes it possible to improve the bonding strength between the external electrode and the solder.

(2) In the coil component of (1) above, the outer surface may include a mounting surface, and the external electrode may be provided only on the mounting surface. In this case, improvement in the bonding strength between the external electrode and the solder is more important compared to a configuration in which the external electrode is provided across a plurality of surfaces. Thus, the configuration in which the plating layer has the protruding portion is especially effective.

(3) In the coil component of (1) or (2) above, the base metal layer may include an embedded portion embedded inside the element body. In this case, the external electrode is less likely to detach from the element body. It is thus possible to improve the mounting strength when mounting the coil component on a circuit board with solder.

(4) In the coil component of (3) above, the outer surface may include a peripheral portion of the external electrode, the embedded portion may include an exposed surface exposed from the outer surface, and a side surface adjoining the exposed surface, and an angle between the peripheral portion and the side surface may be 90 degrees or less. In this case, gaps between the soft magnetic metal particles and the side surface of the embedded portion tend to be large. The surface area of the plating layer that bonds with the solder is further increased by the protruding portion of the plating layer being formed in large gaps. This makes it possible to further improve the bonding strength between the external electrode and the solder.

(5) In the coil component of any one of (1) to (4) above, the base metal layer need not include a glass component. In this case, an area of a base metal material in the surface of the base metal layer is larger compared to a configuration in which the base metal layer includes a glass component. This facilitates plating formation.

(6) In the coil component of any one of (1) to (5) above, the protruding portion may be provided along an entire perimeter of the outer edge portion of the plating layer. This increases the surface area of the plating layer along the entire perimeter of the outer edge portion of the plating layer, making it possible to further improve the bonding strength between the external electrode and the solder.

(7) In the coil component of any one of (1) to (6) above, the outer surface may include a mounting surface, and a pair of end surfaces facing each other and adjoining the mounting surface, a pair of the external electrodes may be provided on the mounting surface spaced apart from each other in a facing direction of the pair of end surfaces, the mounting surface may include a center region disposed between the pair of the external electrodes when viewed in a direction perpendicular to the mounting surface, and the protruding portion may be provided on the outer edge portion of the plating layer adjacent the center region. In this case, stress tends to be applied between the center region and the external electrodes when mounting the coil component on a circuit board. The bonding strength between the external electrodes and the solder can be improved in the portion where stress tends to be applied when mounting the coil component by the protruding portion being provided along the center region.

(8) In the coil component of any one of (1) to (7) above, the element body may include a first region provided in contact with the external electrode, and a second region provided in contact with the coil, and the soft magnetic metal particles included in the first region may have an average particle size greater than an average particle size of the soft magnetic metal particles included in the second region. This facilitates the forming of the protruding portion while maintaining the properties of the coil.

(9) In the coil component of any one of (1) to (8) above, an average depth of the protruding portion penetrating into the element body may be half or more of the average particle size of the soft magnetic metal particles. This makes it possible to reliably improve the bonding strength between the external electrode and the solder.

### BRIEF DESCRIPTION OF THE DRAWINGS

FIG. 1 is a perspective view of a coil component according to a first embodiment.

FIG. 2 is a transparent perspective view of the coil component illustrated in FIG. 1.

FIG. 3 is an exploded perspective view of the coil component illustrated in FIG. 1.

FIG. 4 is the coil component illustrated in FIG. 1 viewed from a mounting surface side.

FIG. 5 is a cross-sectional view of the coil component illustrated in FIG. 1.

FIG. 6 is a perspective view of a coil component according to a second embodiment.

FIG. 7 is a cross-sectional view of the coil component illustrated in FIG. 6.

FIG. 8 is an exploded perspective view of the coil component illustrated in FIG. 6.

FIG. 9 is a cross-sectional view of a coil component according to a first variation of the first embodiment.

FIG. 10 is a cross-sectional view of a coil component according to a second variation of the first embodiment.

### DETAILED DESCRIPTION

Embodiments of the present disclosure will be described in detail below with reference to the accompanying drawings. Same reference signs are given to the same or corresponding elements in the description of the drawings, and redundant description will be omitted.

### First Embodiment

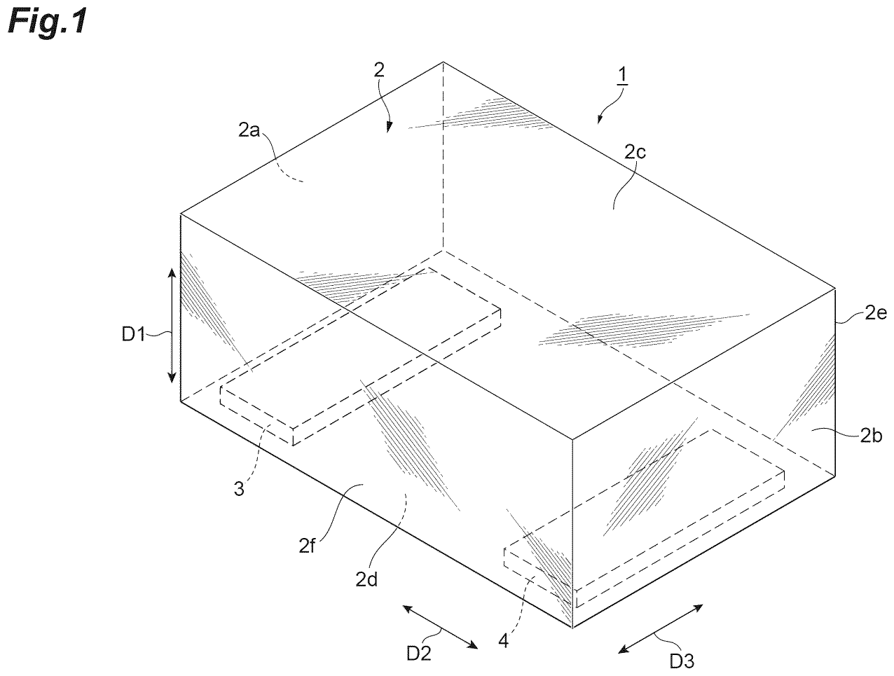

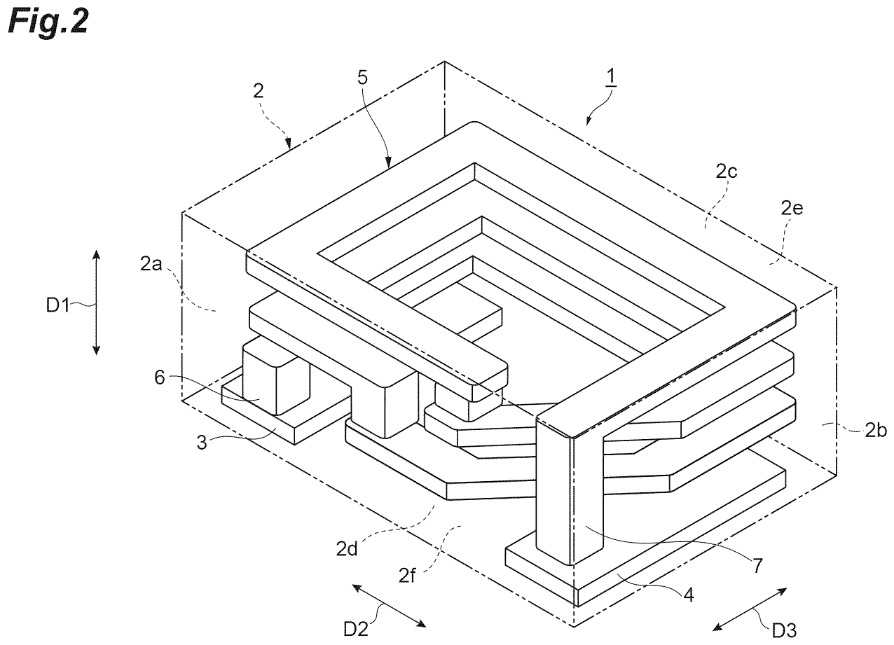

A coil component 1 according to a first embodiment will be described with reference to FIGS. 1 to 5. As illustrated in FIGS. 1 to 5, the coil component 1 includes an element body 2, an external electrode 3, an external electrode 4, a coil 5, a first connecting conductor 6, and a second connecting conductor 7. The coil component 1 is a laminated coil component. In FIG. 2, the element body 2 is shown in broken lines for ease of explanation.

The element body 2 has a rectangular parallelepiped shape. The rectangular parallelepiped shape includes a rectangular parallelepiped shape in which the corners and edges are chamfered, and a rectangular parallelepiped shape in which the corners and edges are rounded. An outer surface 2s of the element body 2 has a pair of end surfaces 2a, 2b, a pair of main surfaces 2c, 2d, and a pair of side surfaces 2e, 2f. The end surfaces 2a, 2b face each other. The main surfaces 2c, 2d face each other. The side surfaces 2e, 2f face each other. In this embodiment, a facing direction of the main surfaces 2c, 2d is a first direction D1, a facing direction of the end surfaces 2a, 2b is a second direction D2, and a facing direction of the side surfaces 2e, 2f is a third direction D3. The first direction D1, the second direction D2, and the third direction D3 are substantially perpendicular to each other.

The end surfaces 2a, 2b extend in the first direction D1 so as to connect the main surfaces 2c, 2d. The end surfaces 2a, 2b also extend in the third direction D3 so as to connect the side surfaces 2e, 2f. The main surfaces 2c, 2d extend in the second direction D2 so as to connect the end surfaces 2a, 2b. The main surfaces 2c, 2d also extend in the third direction D3 so as to connect the side surfaces 2e, 2f. The side surfaces 2e, 2f extend in the first direction D1 so as to connect the main surfaces 2c, 2d. The side surfaces 2e, 2f also extend in the second direction D2 so as to connect the end surfaces 2a, 2b.

The main surface 2d is a mounting surface, and for example, when the coil component 1 is mounted on another electronic device not shown (e.g., a circuit substrate or a laminated coil component), it is the surface that faces the other electronic device. The end surfaces 2a, 2b are surfaces continuing from the mounting surface (i.e., the main surface 2d). The end surfaces 2a, 2b are also surfaces adjoining the mounting surface.

The element body 2 has a length in the second direction D2 that is greater than a length of the element body 2 in the first direction D1 and a length of the element body 2 in the third direction D3. The element body 2 has a length in the third direction D3 that is greater than the length of the element body 2 in the first direction D1. That is, in this embodiment, the end surfaces 2a, 2b, the main surfaces 2c, 2d, and the side surfaces 2e, 2f have rectangular shapes. The length of the element body 2 in the first direction D1 may be equal to or shorter than the length of the element body 2 in the third direction D3.

In the description of this embodiment, the term “equal” means the same, and may also refer to values including minute differences or manufacturing errors within a preset range, and the like. For example, if a plurality of values are within a ±5% range of the average of the plurality of values, it is defined that the plurality of values are equal.

The element body 2 is formed of a plurality of element body layers (magnetic layers) 10a to 10h being laminated in the first direction D1. That is, a lamination direction of the element body 2 is the first direction D1. The specific lamination configuration will be described further below. In the actual element body 2, the plurality of element body layers 10a to 10h are integrated such that the boundaries between the layers cannot be visually recognized.

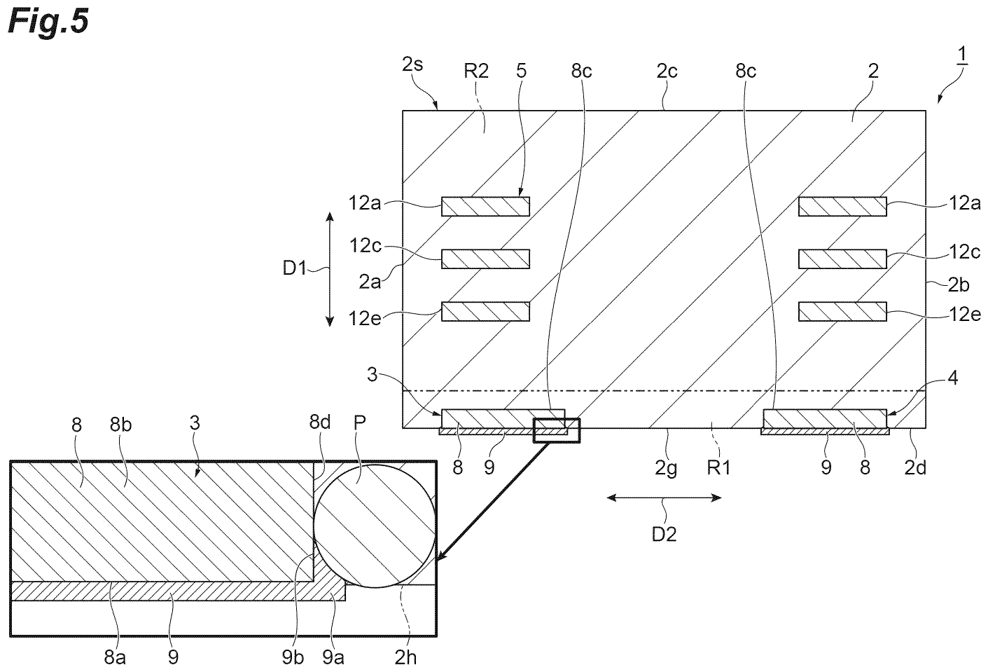

The element body 2 includes a plurality of soft magnetic metal particles P (see FIG. 5). The soft magnetic metal particles P are formed of a soft magnetic alloy (soft magnetic material). The soft magnetic alloy is, for example, an Fe—Si alloy. In the case in which the soft magnetic alloy is an Fe—Si alloy, the soft magnetic alloy may include P. The soft magnetic alloy may be, for example, an Fe—Ni—Si-M alloy. “M” includes one or more elements selected from the group consisting of Co, Cr, Mn, P, Ti, Zr, Hf, Nb, Ta, Mo, Mg, Ca, Sr, Ba, Zn, B, Al, and rare earth elements.

In the element body 2, the soft magnetic metal particles P, P are bonded to each other. The bonding of the soft magnetic metal particles P, P is achieved, for example, by the bonding of oxide films (not shown) formed on the surfaces of the soft magnetic metal particles P. The oxide film has a thickness, for example, of 5 nm or more and 60 nm or less. The oxide film may be formed of one or a plurality of layers. A resin is present in at least a part of the gaps between the soft magnetic metal particles P, P. The resin has electrical insulation properties, and for example, may be a silicone resin, a phenol resin, an acrylic resin, or an epoxy resin.

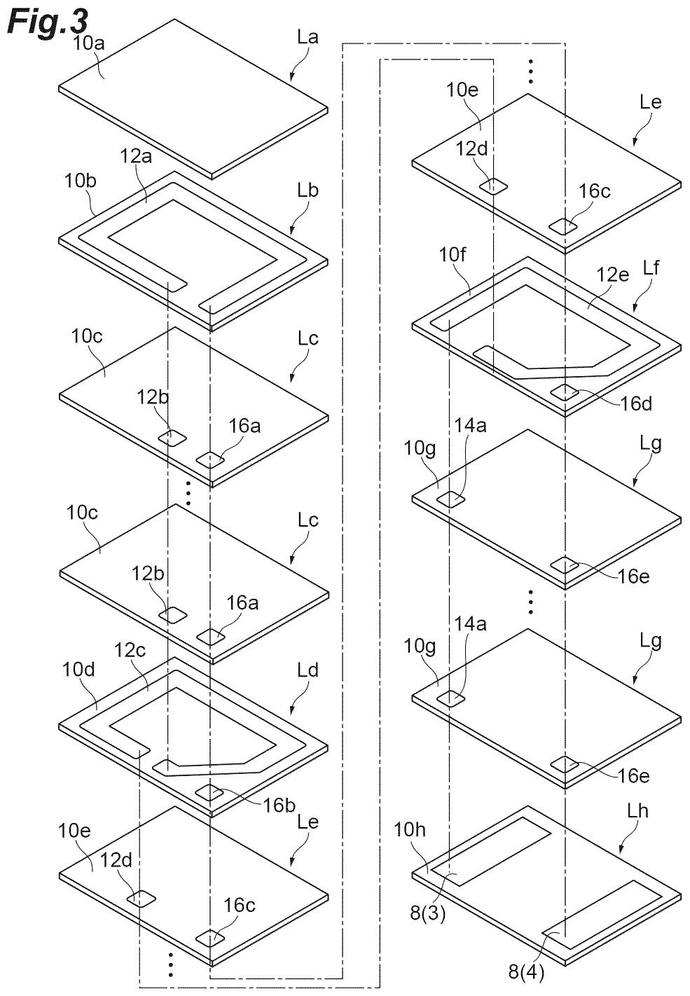

As illustrated in FIG. 5, the element body 2 has a first region R1 that is provided in contact with the external electrodes 3, 4, and a second region R2 that is provided in contact with the coil 5. In this embodiment, the first region R1 includes the entire main surface 2d, and is a region thicker than an embedded portion 8b in the first direction D1. The second region R2 is the entire region of the element body 2 excluding the first region R1. The gaps between the soft magnetic metal particles P, P in the first region R1 have a size (volume) greater than a size (volume) of the gaps between the soft magnetic metal particles P, P in the second region R2. For example, the first region R1 includes the element body layer 10h (see FIG. 3), and one element body layer 10g (see FIG. 3) adjoining the element body layer 10h. The second region R2 includes the remaining element body layers.

The external electrode 3 and the external electrode 4 are provided on the element body 2, and are connected to the coil 5. The external electrode 3 and the external electrode 4 are so-called bottom electrodes, and are provided only on the mounting surface (main surface 2d). The external electrode 3 and the external electrode 4 have the same shape. The external electrode 3 and the external electrode 4 are provided on the mounting surface (main surface 2d) spaced apart from each other in the second direction D2. Specifically, the external electrode 3 is disposed closer to the end surface 2a of the element body 2, and the external electrode 4 is disposed closer to the end surface 2b of the element body 2.

The coil 5 is disposed inside the element body 2. As illustrated in FIG. 3, the coil 5 is formed of a plurality of coil conductor layers 12a to 12e. The plurality of coil conductor layers 12a to 12e are electrically connected to each other, and form the coil 5 inside the element body 2. A coil axis of the coil 5 is provided along the first direction D1. The coil conductor layers 12a to 12e are disposed so that at least portions thereof overlap each other when viewed in the first direction D1. The plurality of coil conductor layers 12a to 12e are formed of a conductive material (e.g., Ag or Pd). In this embodiment, the plurality of coil conductor layers 12a, 12c, 12e are plated conductors. The coil conductor layers 12a to 12e are disposed spaced apart from the end surfaces 2a, 2b, the main surfaces 2c, 2d, and the side surfaces 2e, 2f.

As illustrated in FIG. 2, the first connecting conductor 6 is disposed inside the element body 2. The first connecting conductor 6 connects the external electrode 3 and the coil 5. The first connecting conductor 6 is a through hole conductor. The first connecting conductor 6 extends in the first direction D1, and is connected to the external electrode 3 and one end of the coil 5. The first connecting conductor 6 is formed of a plurality of first connecting conductor layers 14a (see FIG. 3). In this embodiment, a cross-section of the first connecting conductor 6 perpendicular to a direction of extension (first direction D1) (cross-section along the second direction D2 and the third direction D3) has a rectangular shape. That is, the first connecting conductor 6 has a rectangular prism shape.

The second connecting conductor 7 is disposed inside the element body 2. The second connecting conductor 7 connects the external electrode 4 and the coil 5. The second connecting conductor 7 is a through hole conductor. The second connecting conductor 7 extends in the first direction D1, and is connected to the external electrode 4 and the other end of the coil 5. The second connecting conductor 7 is formed of a plurality of second connecting conductor layers 16a, 16b, 16c, 16d, 16e (see FIG. 3). In this embodiment, a cross-section of the second connecting conductor 7 perpendicular to a direction of extension (first direction D1) (cross-section along the second direction D2 and the third direction D3) has a rectangular shape. That is, the second connecting conductor 7 has a rectangular prism shape.

As illustrated in FIG. 3, the coil component 1 includes a plurality of layers La, Lb, Lc, Ld, Le, Lf, Lg, Lh. The coil component 1 is formed, for example, by the layers La to Lh being laminated in order from the main surface 2c. The coil component 1 according to this embodiment includes a plurality of the layers Lc and Lg.

The layer La is formed of the element body layer 10a. The layer La forms the main surface 2c of the element body 2.

The layer Lb is formed by the element body layer 10b and the coil conductor layer 12a being combined with each other. The element body layer 10b is provided with a cutout portion (hole) (not shown) that has a shape corresponding to that of the coil conductor layer 12a, and into which the coil conductor layer 12a is fitted. The element body layer 10b has a mutually complementary relationship with the coil conductor layer 12a.

The layer Lc is formed by the element body layer 10c, the coil conductor layer 12b, and the second connecting conductor layer 16a being combined with each other. The element body layer 10c is provided with cutout portions (holes) (not shown) that have shapes corresponding to those of the coil conductor layer 12b and the second connecting conductor layer 16a, and into which the coil conductor layer 12b and the second connecting conductor layer 16a are fitted. The element body layer 10c has a mutually complementary relationship with the coil conductor layer 12b and the second connecting conductor layer 16a.

The layer Ld is formed by the element body layer 10d, the coil conductor layer 12c, and the second connecting conductor layer 16b being combined with each other. The element body layer 10d is provided with cutout portions (holes) (not shown) that have shapes corresponding to those of the coil conductor layer 12c and the second connecting conductor layer 16b, and into which the coil conductor layer 12c and the second connecting conductor layer 16b are fitted. The element body layer 10d has a mutually complementary relationship with the coil conductor layer 12c and the second connecting conductor layer 16b.

The layer Le is formed by the element body layer 10e, the coil conductor layer 12d, and the second connecting conductor layer 16c being combined with each other. The element body layer 10e is provided with cutout portions (holes) (not shown) that have shapes corresponding to those of the coil conductor layer 12d and the second connecting conductor layer 16c, and into which the coil conductor layer 12d and the second connecting conductor layer 16c are fitted. The element body layer 10e has a mutually complementary relationship with the coil conductor layer 12d and the second connecting conductor layer 16c.

The layer Lf is formed by the element body layer 10f, the coil conductor layer 12e, and the second connecting conductor layer 16d being combined with each other. The element body layer 10f is provided with cutout portions (holes) (not shown) that have shapes corresponding to those of the coil conductor layer 12e and the second connecting conductor layer 16d, and into which the coil conductor layer 12e and the second connecting conductor layer 16d are fitted. The element body layer 10f has a mutually complementary relationship with the coil conductor layer 12e and the second connecting conductor layer 16d.

The layer Lg is formed by the element body layer 10g, the first connecting conductor layer 14a, and the second connecting conductor layer 16e being combined with each other. The element body layer 10g is provided with cutout portions (holes) (not shown) that have shapes corresponding to those of the first connecting conductor layer 14a and the second connecting conductor layer 16e, and into which the first connecting conductor layer 14a and the second connecting conductor layer 16e are fitted. The element body layer 10g has a mutually complementary relationship with the first connecting conductor layer 14a and the second connecting conductor layer 16e.

The layer Lh is formed by the element body layer 10h, a base metal layer 8 of the external electrode 3, and a base metal layer 8 of the external electrode 4 being combined with each other. The element body layer 10h is provided with cutout portions (holes) (not shown) that have shapes corresponding to those of the base metal layers 8, and into which the base metal layers 8 are fitted. The element body layer 10h has a mutually complementary relationship with the base metal layer 8 of the external electrode 3 and the base metal layer 8 of the external electrode 4. The layer Lh forms the main surface 2d of the element body 2.

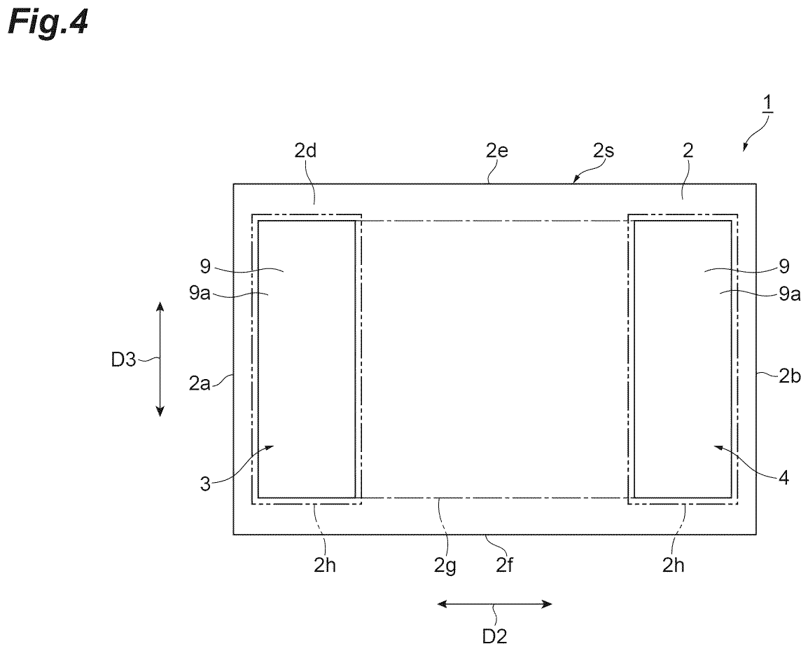

The external electrode 3 and the external electrode 4 will next be described in detail. As illustrated in FIG. 4, the external electrode 3 and the external electrode 4 have a rectangular shape with the second direction D2 being a short side direction, and the third direction D3 being the long side direction when viewed in the first direction D1. The external electrode 3 and the external electrode 4 are disposed spaced apart from outer edges of the main surface 2d.

The mounting surface (main surface 2d) has a center region 2g disposed between the external electrode 3 and the external electrode 4 when viewed in the first direction D1 perpendicular to the mounting surface. The center region 2g has a rectangular shape. The outer surface 2s has a pair of peripheral portions 2h surrounding the external electrode 3 and the external electrode 4, respectively. The peripheral portions 2h have a rectangular ring shape.

As illustrated in FIG. 5, each of the external electrodes 3, 4 has the base metal layer 8 and a plating layer 9. The base metal layer 8 is provided on the outer surface 2s. The base metal layer 8 is provided only on the mounting surface (main surface 2d). The base metal layer 8 has an exposed surface 8a exposed from the element body 2. In this embodiment, the exposed surface 8a forms the same plane as the main surface 2d.

The base metal layer 8 has the embedded portion 8b embedded inside the element body 2. The embedded portion 8b is the portion positioned inward of the element body 2 than the outer surface 2s (here, the main surface 2d). In this embodiment, the entire base metal layer 8 forms the embedded portion 8b. The embedded portion 8b has a facing surface 8c that faces the exposed surface 8a, and four side surfaces 8d adjoining the exposed surface 8a. The side surfaces 8d extend inward into the element body 2 so as to connect the exposed surface 8a and the facing surface 8c. Angles between the side surfaces 8d and the peripheral portion 2h are, for example, less than 90 degrees. In a case in which the side surfaces 8d and the peripheral portion 2h are spaced apart from each other, angles between virtual planes including the side surfaces 8d and a virtual plane including the peripheral portion 2h may be the angles between the side surfaces 8d and the peripheral portion 2h. It can also be said that angles between the side surfaces 8d and the exposed surface 8a are, for example, 90 degrees or more. The angles between the side surfaces 8d and the peripheral portion 2h may be 90 degrees or more.

The base metal layer 8 is formed of a conductive material such as Ag, Cu, Ni, Sn, or Au. The base metal layer 8 does not substantially include a glass component. The content of the glass component in the base metal layer 8 is, for example, less than 0.5%. Thus, an area of a base metal material in the surface of the base metal layer 8 is larger compared to a base metal layer including a glass component. This facilitates plating formation.

The plating layer 9 covers the base metal layer 8. The plating layer 9 covers the entire exposed surface 8a. The plating layer 9 has a protruding portion 9b that is provided on an outer edge portion 9a of the plating layer 9, and penetrates into the element body 2. The protruding portion 9b covers end portions of the side surfaces 8d closer to the exposed surface 8a. The protruding portion 9b is, for example, provided on the outer edge portion 9a adjacent the center region 2g. The protruding portion 9b is, for example, provided along the entire perimeter of the outer edge portion 9a.

The protruding portion 9b is formed by plating penetrating into the gaps between the soft magnetic metal particles P and the embedded portion 8b. An average depth of the protruding portion 9b penetrating into the element body 2 is, for example, half or more of an average particle size of the soft magnetic metal particles P.

The average particle size of the soft magnetic metal particles P is obtained, for example, as described below. A cross-sectional photograph of the coil component 1 is obtained. The obtained cross-sectional photograph is subjected to image processing by a software. Boundaries of the soft magnetic metal particles P are distinguished by the image processing, and the areas of the soft magnetic metal particles P are determined. Each particle size converted into an equivalent circle diameter is determined from the determined areas of the soft magnetic metal particles P. Here, the particle sizes of 100 or more of the soft magnetic metal particles P are calculated, and a particle size distribution of these soft magnetic metal particles P is determined. A particle size at 50% of the cumulative value of the determined particle size distribution (d50) is the “average particle size.” The particle shape of the soft magnetic metal particles P is not limited.

The average depth of the protruding portion 9b is obtained, for example, as described below. A cross-sectional photograph of the coil component 1 is obtained. The cross-sectional photograph is obtained, for example, by photographing a cross-section of the coil component 1 cut along a plane parallel to the side surfaces 2e, 2f and passing through the external electrodes 3, 4. A plurality of cross-sectional photographs are obtained by changing the position in the third direction D3. In the obtained cross-sectional photographs, with the plane including the main surface 2d as a reference plane, a length in the first direction D1 from the reference plane to a tip end of the protruding portion 9b is determined as the depth of the protruding portion 9b. A maximum of four depths of the protruding portion 9b is determined from one cross-sectional photograph. Here, for example, the depths of the protruding portion 9b are determined from five or more cross-sectional photographs, and an average value of these depths is the “average depth” of the protruding portion 9b.

A method of manufacturing the coil component 1 will next be described. A slurry including the soft magnetic metal particles P is prepared by mixing the soft magnetic metal particles P with an insulating resin, a solvent, etc. The slurry is provided on a substrate (e.g., a PET film), for example, by screen printing or a doctor blade method, and a green sheet to be the element body layer 10a is formed on the substrate.

A conductive pattern is formed on the substrate by plating or screen printing. The slurry is then applied onto the substrate, for example, by screen printing so as to fill in the surrounding areas of the conductive pattern. Thus, the green sheets to be the plurality of the element body layers 10b, 10c, 10d, 10e, 10f, 10g, 10h are formed on the substrate.

In this embodiment, a first slurry for forming the first region R1 and a second slurry for forming the second region R2 are prepared as the slurry above. A content of the insulating resin and the solvent in the first slurry is greater than a content of the insulating resin and the solvent in the second slurry. For example, the first slurry is used to form the element body layer 10h and one element body layer 10g adjoining the element body layer 10h. The second slurry is used to form the rest of the element body layers.

The green sheets to be the plurality of the element body layers 10a to 10h are then transferred and laminated in that order together with the conductive patterns. These are pressed in the lamination direction to form a laminated substrate of green sheets. The laminated substrate is then cut into chips of a predetermined size by a cutter having a rotating blade to form individualized laminated bodies. Subsequently, the individualized laminated bodies are fired to form laminated bodies. The insulating resin and the solvent of the slurry are burned off by the firing, and gaps are formed between the soft magnetic metal particles P, P. Since the content of the insulating resin and the solvent in the first slurry is greater than the content of the insulating resin and the solvent in the second slurry, the size of the gaps in the first region R1 are greater than the size of the gaps in the second region R2.

Each laminated body is then soaked in a resin liquid to impregnate the laminated body with resin, which is cured by heat. The element body 2 is thus formed. Next, the plating layer 9 is formed by plating. When doing so, the protruding portion 9b is easily formed in the first region R1 since the volume of the gaps is large. Consequently, the coil 1 is formed.

As described above, the plating layer 9 has the protruding portion 9b that penetrates into the element body 2 in the coil component 1 according to this embodiment. Thus, a surface area of the plating layer 9 that bonds with the solder is increased compared to a configuration in which the plating layer 9 does not have the protruding portion 9b. This makes it possible to improve the bonding strength between the external electrodes 3, 4 and the solder.

Since the external electrodes 3, 4 are provided only on the main surface 2d which is the mounting surface, improvement in the bonding strength between the external electrodes 3, 4 and the solder is more important compared to a configuration in which the external electrodes 3, 4 are provided across a plurality of surfaces of the element body 2. Thus, the configuration in which the plating layer 9 has the protruding portion 9b is especially effective.

The base metal layer 8 has the embedded portion 8b embedded inside the element body 2. The external electrodes 3, 4 are thus less likely to detach from the element body 2. This makes it possible to improve the mounting strength when mounting the coil component 1 on a circuit board with solder.

The angles between the peripheral portion 2h of the element body 2 and the side surfaces 8d of the embedded portion 8b are less than 90 degrees. Thus, the gaps between the soft magnetic metal particles P and the side surfaces 8d tend to be large. The surface area of the plating layer 9 that bonds with the solder is further increased by the protruding portion 9b of the plating layer 9 being formed in large gaps. This makes it possible to further improve the bonding strength between the external electrodes 3, 4 and the solder.

The base metal layer 8 does not include a glass component, so that the area of the base metal material in the surface of the base metal layer 8 is larger compared to a configuration in which the base metal layer 8 includes a glass component. This facilitates plating formation.

The protruding portion 9b is provided along the entire perimeter of the outer edge portion 9a of the plating layer 9. This increases the surface area of the plating layer 9 along the entire perimeter of the outer edge portion 9a, making it possible to further improve the bonding strength between the external electrodes 3, 4 and the solder.

The bonding strength between the external electrodes 3, 4 and the solder can be improved in the portion where stress tends to be applied when mounting the coil component 1, that is, the portion between the center region 2g and the external electrodes 3, 4, by the protruding portion 9b being provided on the outer edge portion 9a adjacent the center region 2g.

The average depth of the protruding portion 9b penetrating into the element body 2 is half or more of the average particle size of the soft magnetic metal particles P. This makes it possible to reliably improve the bonding strength between the external electrodes 3, 4 and the solder.

The average particle size of the soft magnetic metal particles P included in the first region R1 is greater than the average particle size of the soft magnetic metal particles P included in the second region R2. The gaps between the soft magnetic metal particles P, P tend to be large in the first region R1, which facilitates the forming of the protruding portion 9b. The gaps between the soft magnetic metal particles P, P tend to be small in the second region R2, which enables the properties of the coil 5 to be maintained.

### Second Embodiment

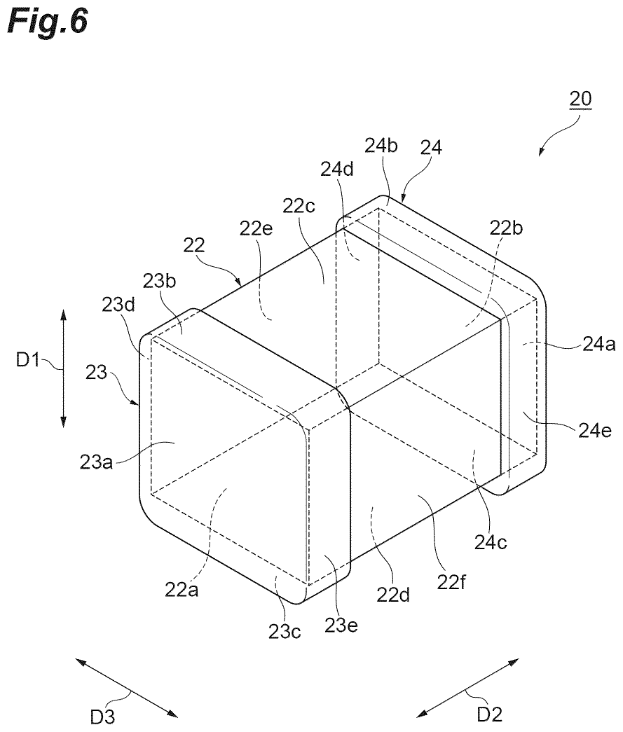

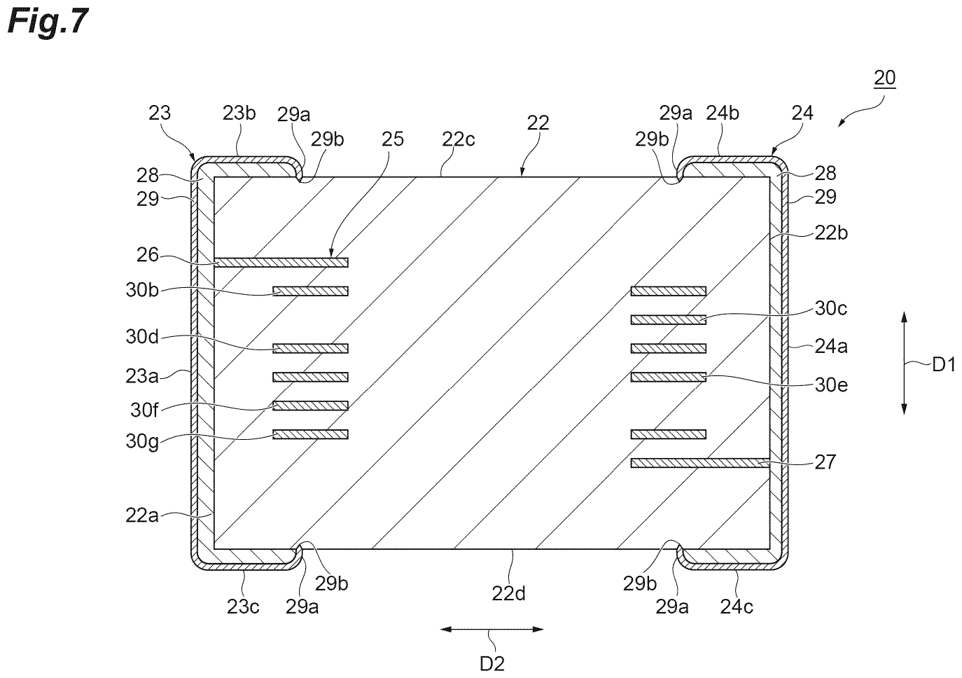

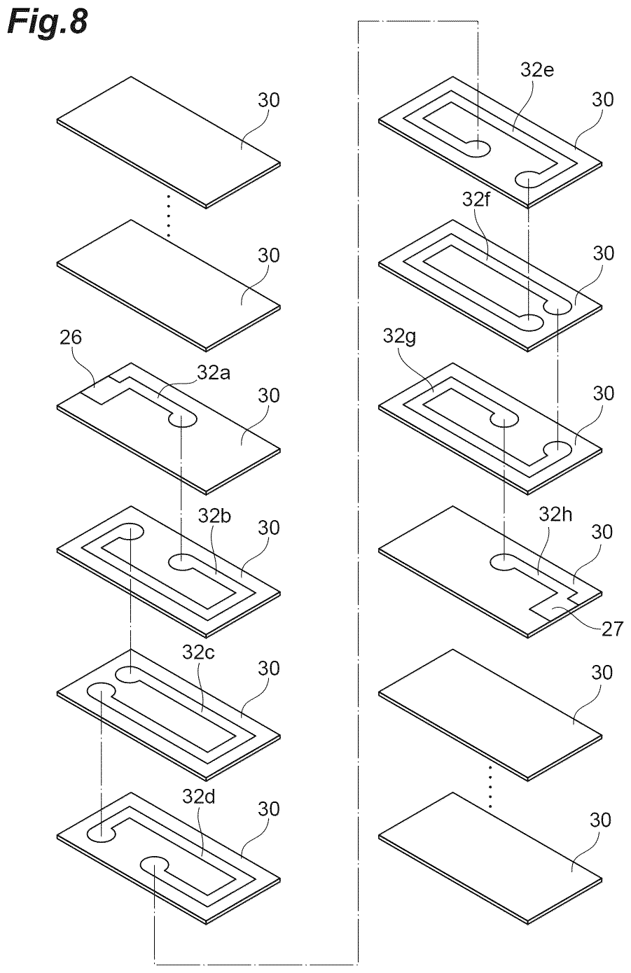

A coil component 20 according to a second embodiment will be described with reference to FIGS. 6 to 8. FIG. 6 is a perspective view of the coil component according to the second embodiment. FIG. 7 is a cross-sectional view of the coil component illustrated in FIG. 6. FIG. 8 is an exploded perspective view of the coil component illustrated in FIG. 6. As illustrated in FIGS. 6 to 8, the coil component 20 includes an element body 22, an external electrode 23, an external electrode 24, a coil 25, a first connecting conductor 26, and a second connecting conductor 27. The coil component 20 is a laminated coil component.

The element body 22 has, for example, the same shape as the element body 2 of the coil component 1. An outer surface 22s of the element body 22 has a pair of end surfaces 22a, 22b, a pair of main surfaces 22c, 22d, and a pair of side surfaces 22e, 22f. The end surfaces 22a, 22b face each other. The main surfaces 22c, 22d face each other. The side surfaces 22e, 22f face each other. In this embodiment, a facing direction of the main surfaces 22c, 22d is a first direction D1, a facing direction of the end surfaces 22a, 22b is a second direction D2, and a facing direction of the side surfaces 22e, 22f is a third direction D3. The first direction D1, the second direction D2, and the third direction D3 are substantially perpendicular to each other.

The end surfaces 22a, 22b extend in the first direction D1 so as to connect the main surfaces 22c, 22d. The end surfaces 22a, 22b also extend in the third direction D3 so as to connect the side surfaces 22e, 22f. The main surfaces 22c, 22d extend in the second direction D2 so as to connect the end surfaces 22a, 22b. The main surfaces 22c, 22d also extend in the third direction D3 so as to connect the side surfaces 22e, 22f. The side surfaces 22e, 22f extend in the first direction D1 so as to connect the main surfaces 22c, 22d. The side surfaces 22e, 22f also extend in the second direction D2 so as to connect the end surfaces 22a, 22b.

The main surface 22d is a mounting surface, and for example, when the coil component 1 is mounted on another electronic device not shown (e.g., a circuit substrate or a laminated coil component), it is the surface that faces the other electronic device. The end surfaces 22a, 22b are surfaces continuing from the mounting surface (i.e., the main surface 22d). The end surfaces 22a, 22b are surfaces adjoining the mounting surface.

The end surfaces 22a, 22b have, for example, the same shape as the end surfaces 2a, 2b of the coil component 1. The main surfaces 22c, 22d have, for example, the same shape as the main surfaces 2c, 2d of the coil component 1. The side surfaces 22e, 22f have, for example, the same shape as the side surfaces 2e, 2f of the coil component 1.

The element body 22 is formed of a plurality of element body layers (magnetic layers) 30 being laminated in the first direction D1. That is, a lamination direction of the element body 22 is the first direction D1. The specific lamination configuration will be described further below. In the actual element body 22, the plurality of element body layers 30 are integrated such that the boundaries between the layers cannot be visually recognized. The element body 22 is made, for example, of the same material as the element body 2 of the coil component 1, and includes a plurality of soft magnetic metal particles P (see FIG. 5). A resin is present in at least a part of the gaps between the soft magnetic metal particles P, P. The resin has electrical insulation properties, and for example, may be a silicone resin, a phenol resin, an acrylic resin, or an epoxy resin.

The external electrode 23 and the external electrode 24 are provided on the element body 22, and are connected to the coil 25. The external electrode 23 and the external electrode 24 are provided at end portions of the element body 22 in the second direction D2, and are spaced apart from each other in the second direction D2. The external electrode 23 and the external electrode 24 have the same shape.

The external electrode 23 is disposed on the end surface 22a side of the element body 22. The external electrode 23 includes five electrode portions: a first electrode portion 23a positioned on the end surface 22a, a second electrode portion 23b positioned on the main surface 22c, a third electrode portion 23c positioned on the main surface 22d, a fourth electrode portion 23d positioned on the side surface 22e, and a fifth electrode portion 23e positioned on the side surface 22f. The first electrode portion 23a is connected to the second electrode portion 23b, the third electrode portion 23c, the fourth electrode portion 23d, and the fifth electrode portion 23e at edge portions of the element body 22, and they are electrically connected to each other. The external electrode 23 is formed on the five surfaces of the end surface 22a, the pair of the main surfaces 22c, 22d, and the pair of the side surfaces 22e, 22f. The first electrode portion 23a, the second electrode portion 23b, the third electrode portion 23c, the fourth electrode portion 23d, and the fifth electrode portion 23e are integrally formed.

In this embodiment, edges (end surfaces) of the second electrode portion 23b and the third electrode portion 23c of the external electrode 23 extend, for example, along the third direction D3. The edge of the second electrode portion 23b is formed linearly on the main surface 22c. The edge of the third electrode portion 23c is formed linearly on the main surface 22d. Edges of the fourth electrode portion 23d and the fifth electrode portion 23e of the external electrode 23 extend along the first direction D1. The edge of the fourth electrode portion 23d is formed linearly on the side surface 22e. The edge of the fifth electrode portion 23e is formed linearly on the side surface 22f. It should be noted that the edges of the second electrode portion 23b, the third electrode portion 23c, the fourth electrode portion 23d, and the fifth electrode portion 23e may be bent or formed unevenly.

The external electrode 24 is disposed on the end surface 22b side of the element body 22. The external electrode 24 includes five electrode portions: a first electrode portion 24a positioned on the end surface 22b, a second electrode portion 24b positioned on the main surface 22c, a third electrode portion 24c positioned on the main surface 22d, a fourth electrode portion 24d positioned on the side surface 22e, and a fifth electrode portion 24e positioned on the side surface 22f. The first electrode portion 24a is connected to the second electrode portion 24b, the third electrode portion 24c, the fourth electrode portion 24d, and the fifth electrode portion 24e at edge portions of the element body 22, and they are electrically connected to each other. The external electrode 24 is formed on the five surfaces of the end surface 22b, the pair of the main surfaces 22c, 22d, and the pair of the side surfaces 22e, 22f. The first electrode portion 24a, the second electrode portion 24b, the third electrode portion 24c, the fourth electrode portion 24d, and the fifth electrode portion 24e are integrally formed.

In this embodiment, edges of the second electrode portion 24b and the third electrode portion 24c of the external electrode 24 extend, for example, along the third direction D3. The edge of the second electrode portion 24b is formed linearly on the main surface 22c. The edge of the third electrode portion 24c is formed linearly on the main surface 22d. Edges of the fourth electrode portion 24d and the fifth electrode portion 24e of the external electrode 24 extend along the first direction D1. The edge of the fourth electrode portion 24d is formed linearly on the side surface 22e. The edge of the fifth electrode portion 24e is formed linearly on the side surface 22f. It should be noted that the edges of the second electrode portion 24b, the third electrode portion 24c, the fourth electrode portion 24d, and the fifth electrode portion 24e may be bent or formed unevenly.

Each of the external electrodes 23, 24 has a base metal layer 28 and a plating layer 29. The base metal layer 28 is provided on the outer surface 22s. The base metal layer 28 of the external electrode 23 is formed on the five surfaces of the end surface 22a, the pair of the main surfaces 22c, 22d, and the pair of the side surfaces 22e, 22f. The base metal layer 28 of the external electrode 24 is formed on the five surfaces of the end surface 22b, the pair of the main surfaces 22c, 22d, and the pair of the side surfaces 22e, 22f. The base metal layer 28 is, for example, provided on the outside of the element body 22, and is not embedded inside the element body 22. The base metal layer 28 is formed of a conductive material such as Ag, Cu, Ni, Sn, or Au. The base metal layer 28 includes, for example, a glass component, but may substantially be free of a glass component.

The plating layer 29 covers the base metal layer 28. The plating layer 29 covers the entire outer surface of the base metal layer 28. The plating layer 29 has a protruding portion 29b that is provided on an outer edge portion 29a of the plating layer 29, and penetrates into the element body 2. The protruding portion 29b is, for example, provided along the entire perimeter of the outer edge portion 29a. The protruding portion 29b may, for example, be provided on the outer edge portion 29a of only the main surface 22d (mounting surface) among the main surfaces 22c, 22d and the side surfaces 22e, 22f.

The protruding portion 29b is formed by plating penetrating into the gaps between the soft magnetic metal particles P (see FIG. 5). An average depth of the protruding portion 29b penetrating into the element body 22 is, for example, half or more of the average particle size of the soft magnetic metal particles P.

The coil 25 is disposed inside the element body 22. The coil 25 is formed of a plurality of coil conductors 32a to 32h (see FIG. 8). The plurality of coil conductors 32a to 32h are electrically connected to each other, and form the coil 25 inside the element body 22. A coil axis of the coil 25 is provided along the first direction D1. Adjoining coil conductors 32a to 32h are electrically connected by a through hole conductor (not shown). The coil conductors 32a to 32h are disposed spaced apart from the end surfaces 22a, 22b, the main surfaces 22c, 22d, and the side surfaces 22e, 22f.

The first connecting conductor 26 is disposed inside the element body 22. The first connecting conductor 26 connects the external electrode 23 and the coil 25. The first connecting conductor 26 is connected to the external electrode 23 and one end of the coil 25. The first connecting conductor 26 is integrally formed with the coil conductor 32a.

The second connecting conductor 27 is disposed inside the element body 22. The second connecting conductor 27 connects the external electrode 24 and the coil 25. The second connecting conductor 27 is connected to the external electrode 24 and the other end of the coil 25. The second connecting conductor 27 is integrally formed with the coil conductor 32h.

The coil conductors 32a to 32h, the first connecting conductor 26, and the second connecting conductor 27 are made of a conductive material typically used as a conductor of a coil. For example, Ag, Cu, Au, Al, Pd, or a Pd/Ag alloy may be used as the conductive material. In this embodiment, the conductive material is Ag. The coil conductors 32a to 32h, the first connecting conductor 26, and the second connecting conductor 27 are formed as a sintered body of a conductive paste including the conductive material.

In a method of manufacturing the coil component 20, the content of the insulating resin and the solvent in the slurry may also be adjusted to increase the volume of the gaps in the region of the element body 22 in contact with the outer edge portion 29a of the plating layer 29.

As described above, the plating layer 29 has the protruding portion 29b that penetrates into the element body 22 also in the coil component 20 according to this embodiment. Thus, the surface area of the plating layer 29 that bonds with the solder is increased compared to a configuration in which the plating layer 29 does not have the protruding portion 29b. This makes it possible to improve the bonding strength between the external electrodes 23, 24 and the solder.

The average particle size of the soft magnetic metal particles P in a region in the vicinity of the main surface 22d of the element body 22 may, for example, be greater than the average particle size of the soft magnetic metal particles P in other regions. In this case, the protruding portion 29b provided on the main surface 22d will be greater than the protruding portion 29b provided on the main surface 22c and the side surfaces 22e, 22f. Thus, the surface area of the plating layer 29 that bonds with the solder is further increased in the main surface 22d. As a result, the mounting strength can be improved.

Although the embodiments of the present disclosure have been described above, the present disclosure is not necessarily limited to these embodiments, and various modifications are possible without departing from the gist thereof.

In the embodiments above, the coil components 1, 20 have been described as examples of the coil component. However, the coil component is not limited to the coil components 1, 20, and may be other coil components. For example, the numbers and shapes of the coil conductors forming the coils 5, 25 are not limited.

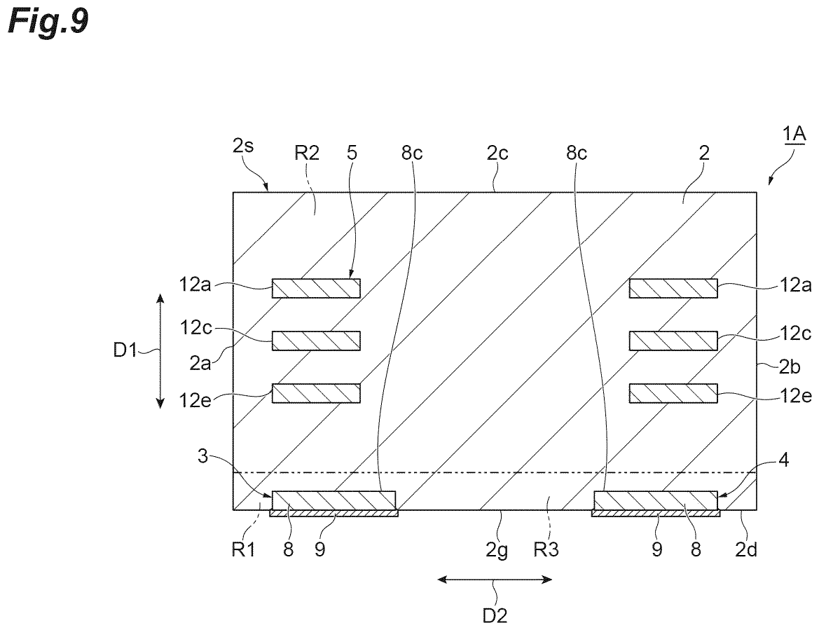

FIG. 9 is a cross-sectional view of a coil component according to a first variation of the first embodiment. As illustrated in FIG. 9, a coil component 1A according to the first variation is different from the coil component 1 in that the first region R1 includes a third region R3. The soft magnetic metal particles P in the third region R3 have an average particle size that is greater than the average particle size of the soft magnetic metal particles P in the remaining region of the first region R1 and the average particle size of the soft magnetic metal particles P in the second region R2. The gaps in the third region R3 have a volume that is equal to the volume of the gaps in the remaining part of the first region R1 and greater than the volume of the gaps in the second region R2.

The third region R3 is, for example, provided between the embedded portions 8b of the external electrodes 3, 4. The third region R3 includes the center region 2g as an outer surface. For example, the third region R3 includes a region of the element body layer 10h that corresponds to the center region 2g. The third region R3 has a thickness (length in the first direction D1) that is, for example, equal to a thickness (length in the first direction D1) of the external electrodes 3, 4.

When manufacturing the coil component 1A, a third slurry for forming the third region R3 is prepared, in addition to the first slurry and the second slurry, as the slurry. A content of the insulating resin and the solvent in the third slurry is equal to the content of the insulating resin and the solvent in the first slurry, and greater than the content of the insulating resin and the solvent in the second slurry. The soft magnetic metal particles P in the third slurry have an average particle size that is greater than the average particle size of the soft magnetic metal particles P in the first slurry and the average particle size of the soft magnetic metal particles P in the second slurry.

The plating layer 9 also has the protruding portion 9b in the coil component 1A, so that effects similar to those of the coil component 1 are obtained. Since the average particle size of the soft magnetic metal particles P is large in the third region R3, the gaps between the side surface 8d and the soft magnetic metal particles P tend to be even larger at the side surface 8d in contact with the third region R3. The surface area of the plating layer 9 that bonds with the solder is further increased by the protruding portion 9b of the plating layer 9 being formed in large gaps. This makes it possible to further improve the bonding strength between the external electrodes 3, 4 and the solder.

The third region R3 includes the center region 2g as the outer surface, so that the protruding portion 9b provided on the outer edge portion 9a adjacent the center region 2g tends to be larger than the protruding portion 9b provided on the outer edge portion 9a separated from the center region 2g. Thus, the average depth of the protruding portion 9b provided on the outer edge portion 9a adjacent the center region 2g can be made greater than the average depth of the protruding portion 9b provided on the outer edge portion 9a separated from the center region 2g. In the case in which the average particle size of the soft magnetic metal particles P differ depending on the place where the protruding portion 9b is provided, the average depth of the protruding portion 9b penetrating into the element body 2 is half or more of the average particle size of the soft magnetic metal particles P provided near the protruding portion 9b.

Although the third region R3 is a part of the first region R1 in the coil component 1A, the third region R3 may be provided over the entire first region R1. In this case, there is no need to prepare the first slurry.

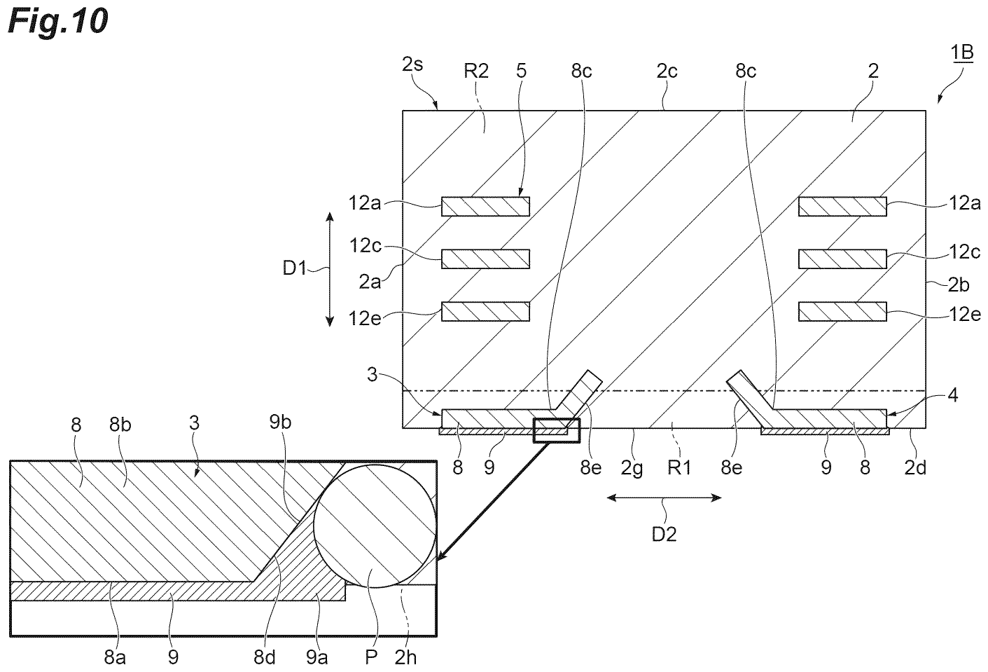

FIG. 10 is a cross-sectional view of a coil component according to a second variation of the first embodiment. As illustrated in FIG. 10, a coil component 1B according to the second variation is different from the coil component 1 in that the base metal layer 8 has a bent portion 8e. The bent portion 8e is bent toward the inside of the element body 2. The bent portion 8e projects toward the center of the element body 2 in the second direction D2 and the center of the element body 2 in the first direction D1 from an end portion of the exposed surface 8a closer to the center region 2g when viewed in the third direction D3. The bent portion 8e overlaps the center region 2g when viewed in the first direction D1. The bent portion 8e is embedded inside the element body 2. The entirety of the base metal layer 8 including the bent portion 8e forms the embedded portion 8b.

The plating layer 9 has the protruding portion 9b also in the coil component 1B, so that effects similar to those of the coil component 1 are obtained. The external electrodes 3, 4 are even less likely to detach from the element body 2, since the base metal layer 8 has the bent portion 8e embedded inside the element body 2 in the coil component 1B. This makes it possible to further improve the mounting strength when mounting the coil component 1B on a circuit board with solder. Cracks originating from the portions between the center region 2g and the external electrodes 3, 4 tend to occur in the element body 2 due to bending stress during mounting. The bent portion 8e is provided at a location where cracks tend to occur in the coil component 1B. Cracks can thus be suppressed.

The bent portion 8e includes one of the four side surfaces 8d. An angle between the side surface 8d of the bent portion 8e and the peripheral portion 2h is, for example, less than angles between the other three side surfaces 8d and the peripheral portion 2h. Thus, the gaps between the side surface 8d of the bent portion 8e and the soft magnetic metal particles P tend to be large. The surface area of the plating layer 9 that bonds with the solder is further increased by the protruding portion 9b of the plating layer 9 being formed in large gaps. This makes it possible to further improve the bonding strength between the external electrodes 3, 4 and the solder.

The bent portion 8e is provided so as to be adjacent the end portion of the exposed surface 8a closer to the center region 2g, so that the protruding portion 9b provided on the outer edge portion 9a adjacent the center region 2g tends to be larger than the protruding portion 9b provided on the outer edge portion 9a separated from the center region 2g. Thus, similarly to the coil component 1A, the average depth of the protruding portion 9b provided on the outer edge portion 9a adjacent the center region 2g can be made greater than the average depth of the protruding portion 9b provided on the outer edge portion 9a separated from the center region 2g.

What is claimed is:

1. A coil component, comprising:
an element body including soft magnetic metal particles;
a coil disposed inside the element body; and
an external electrode connected to the coil,
wherein the external electrode includes a base metal layer provided on an outer surface of the element body, and a plating layer covering the base metal layer, and
wherein the plating layer includes a protruding portion provided on an outer edge portion of the plating layer, and penetrating into the element body.

2. The coil component according to claim 1,
wherein the outer surface includes a mounting surface, and
wherein the external electrode is provided only on the mounting surface.

3. The coil component according to claim 1, wherein the base metal layer includes an embedded portion embedded inside the element body.

4. The coil component according to claim 3,
wherein the outer surface includes a peripheral portion of the external electrode,
wherein the embedded portion includes an exposed surface exposed from the outer surface, and a side surface adjoining the exposed surface, and
wherein an angle between the peripheral portion and the side surface is 90 degrees or less.

5. The coil component according to claim 1, wherein the base metal layer does not include a glass component.

6. The coil component according to claim 1, wherein the protruding portion is provided along an entire perimeter of the outer edge portion of the plating layer.

7. The coil component according to claim 1,
wherein the outer surface includes a mounting surface, and a pair of end surfaces facing each other and adjoining the mounting surface,
wherein a pair of the external electrodes is provided on the mounting surface spaced apart from each other in a facing direction of the pair of end surfaces,
wherein the mounting surface includes a center region disposed between the pair of the external electrodes when viewed in a direction perpendicular to the mounting surface, and
wherein the protruding portion is provided on the outer edge portion of the plating layer adjacent the center region.

8. The coil component according to claim 1,
wherein the element body includes a first region provided in contact with the external electrode, and a second region provided in contact with the coil, and
wherein the soft magnetic metal particles included in the first region have an average particle size greater than an average particle size of the soft magnetic metal particles included in the second region.

9. The coil component according to claim 1, wherein an average depth of the protruding portion penetrating into the element body is half or more of an average particle size of the soft magnetic metal particles.
